(19) United States
(12) Patent Application Publication
(10) Pub. No.: US 2014/0215611 A1
(43) Pub. Date: Jul. 31, 2014

(54) APPARATUS AND METHOD FOR DETECTING ATTACK OF NETWORK SYSTEM

(71) Applicant: Samsung Electronics Co., Ltd., Suwon-si (KR)

(72) Inventors: Eun Ah KIM, Seoul (KR); Dae Youb KIM, Seoul (KR); Byoung Joon LEE, Seongnam-si (KR)

(73) Assignee: Samsung Electronics Co., Ltd., Suwon-si (KR)

(21) Appl. No.: 14/167,087

(22) Filed: Jan. 29, 2014

(30) Foreign Application Priority Data
Jan. 31, 2013 (KR) 10-2013-0010936

(51) Int. Cl. H04L 29/06

(52) U.S. Cl. CPC H04L 63/1416
USPC 726/22

(57) ABSTRACT

An attack detection apparatus includes a window size change unit configured to change a size of a window to be applied to traffic, and an abnormal state detection unit configured to detect an abnormal state of the traffic to which the changed window is applied.

### CROSS-REFERENCE TO RELATED APPLICATION

This application claims the benefit under 35 USC 119(a) of Korean Patent Application No. 10-2013-0010936, filed on Jan. 31, 2013, in the Korean Intellectual Property Office, the entire disclosure of which is incorporated herein by reference for all purposes.

### BACKGROUND

1. Field

The following description relates to an apparatus and method for detecting an attack of a network system.

2. Description of Related Art

Pending Interest Table (PIT)-flooding refers to an attack overflowing an PIT storage of a network system by transmitting a great quantity of interest messages related to contents not present in the network system. As the PIT storage is overflowed, a content search and transmission speed is reduced, and therefore the network system may not normally provide services. In addition, when the network system does not detect the PIT-flooding, the overflowed state of the PIT storage may be maintained, and therefore the network system may not normally provide the services for a long time. Accordingly, a method for quickly detecting the PIT-flooding is demanded.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided an attack detection apparatus including a window size change unit configured to change a size of a window to be applied to traffic, and an abnormal state detection unit configured to detect an abnormal state of the traffic to which the changed window is applied.

The window size change unit may be configured to change the window size based on a first variation denoting a scale and a continuity of a variation of the traffic.

The window size change unit may be configured to determine the first variation based on a second variation denoting a direction of the variation of the traffic.

The window size change unit may be configured to change the window size such that the traffic from a time when the first variation is not 0 to a time when the first variation is 0, is included in the window.

The window size change unit may be configured to change the window size to a default size in response to a time period from a time when the first variation is not 0 to a time when the first variation is 0, being less than the default size.

The abnormal state detection unit may be configured to determine that the abnormal state occurs in response to the first variation exceeding a predetermined threshold.

The attack detection apparatus may further include a cause analysis unit configured to analyze a cause of the abnormal state based on an interest message and data corresponding to the interest message.

The cause analysis unit may be configured to analyze the cause of the abnormal state based on a ratio between the interest message received by a node and the data transmitted by the node.

The cause analysis unit may be configured to analyze the cause of the abnormal state based on an occurrence ratio of a fake interest message, and the fake interest message may request data not present in a network system.

In another general aspect, there is provided an attack detection apparatus including an abnormal state detection unit configured to detect an abnormal state of traffic of a node, and a cause analysis unit configured to analyze a cause of the abnormal state based on an interest message and data corresponding to the interest message.

The cause analysis unit may be configured to analyze the cause of the abnormal state based on a ratio between the interest message received by the node and the data transmitted by the node.

The cause analysis unit may be configured to analyze the cause of the abnormal state based on an occurrence ratio of a fake interest message, and the fake interest message may request data not present in a network system.

The attack detection apparatus may further include a window size change unit configured to change a size of a window to be applied to the traffic. The window size change unit may be configured to change the window size based on a first variation denoting a scale and a continuity of a variation of the traffic, and the abnormal state detection unit is configured to detect the abnormal state of the traffic to which the changed window is applied.

The window size change unit may be configured to change the window size such that the traffic from a time when the first variation is greater than 0 to a time when the first variation is less than 0, in included in the window.

The window size change unit may be configured to change the window size to a default size in response to a time period from a time when the first variation is not 0 to a time when the first variation is 0, being less than the default size.

In still another general aspect, an attack detection method includes changing a size of a window to be applied to traffic of a node, and detecting an abnormal state of the traffic to which the changed window is applied.

The attack detection method may further include analyzing a cause of the abnormal state based on an interest message and data corresponding to the interest message.

The detecting may include detecting whether the node is attacked based on the traffic to which the changed window is applied and a ratio between one or more interest messages received by the node and data transmitted by the node that corresponds to the interest messages.

The changing may include changing the size of the window to a default size in response to a time period from a time when a first variation of the traffic is not 0 to a time when the first variation is 0, being less than the default size, and changing the size of the window to be greater than a default size in response to the time period being greater than the default size.

The detecting may include detecting that the node is attacked in response to a first variation of the traffic to which the changed window is applied, exceeding a predetermined threshold, and the ratio being less than an average of the ratio.

Other features and aspects will be apparent from the following detailed description, the drawings, and the claims.

### BRIEF DESCRIPTION OF THE DRAWINGS

FIG. 1 is a diagram illustrating an example of a network system including an attack detection apparatus.

FIG. 2 is a diagram illustrating an example of an attack detection apparatus.

FIG. 3 is a graph illustrating an example of a variation used by an attack detection apparatus.

FIG. 4 is a graph illustrating an example of a response rate used by an attack detection apparatus.

FIG. 5 is a flowchart illustrating an example of an attack detection method.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

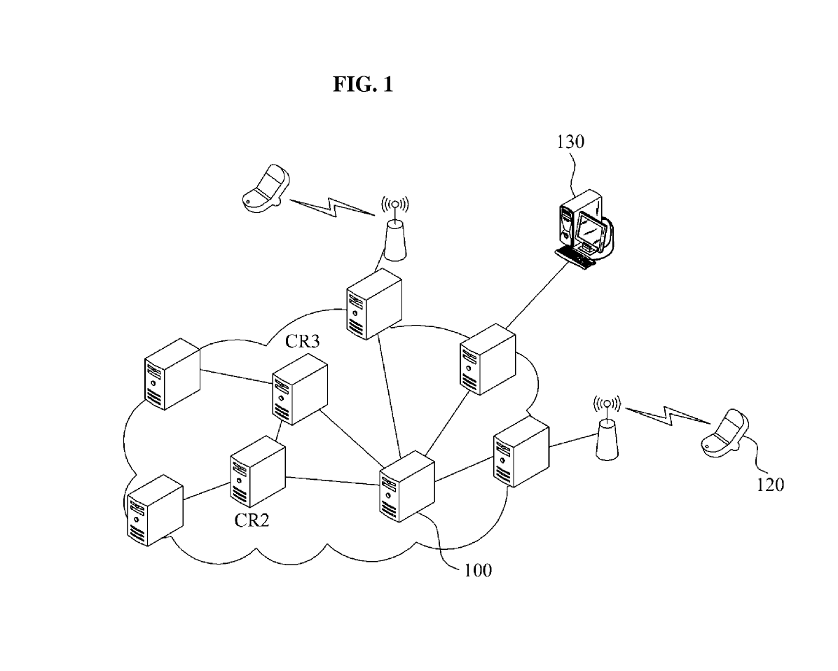

FIG. 1 is a diagram illustrating an example of a network system including an attack detection apparatus. A node 100 of the network system may include the attack detection apparatus, and therefore detect an attack by attackers that disables a server of the network system. The attack detection apparatus may detect attacks, such as a denial of service (DoS) and a distributed DoS (DDos), which disable a service by generating a great amount of traffic.

The network system may be a content centric network that provides contents stored in a content node 130 to a user node 120, according to a request by the user node 120. The user node 120 may request for transmission of content by transmitting an interest message or an interest packet that is destined to a content name to the network system. The interest message may be transmitted to various network devices included in the network system.

Next, the node 100 may receive the interest message, and search whether the content requested by the user node 120 is stored in the node 100. In detail, the node 100 may search a content storage identified by the content name.

When the node 100 determines that the content corresponding to the interest message is stored in the node 100, the node 100 may provide data including the content as a response to the user node 120 through a network interface through which the interest message is received.

When the node 100 determines that the content corresponding to the interest message is not stored in the node 100, the node 100 may record the content name corresponding to the interest message, and the network interface through which the interest message is received, in a Pending Interest Table (PIT), and may transmit the interest message to another network node by referencing a content routing table (for example, a Forwarding Interest Base (FIB)). In this latter example, the content node 130 may receive the interest message transmitted through at least one other network node, and transmit the data including the content as a response through the at least one other network node to the user node 120. Next, the node 100 may receive the data including the content from the other network node. Next, the node 100 may transmit the data including the content to the user node 120 through the network interface through which the interest message is received, by referencing the PIT.

However, when an attacker transmits a great quantity of fake interest messages, which refer to content not actually present, processing of normal interest messages may be delayed because the node 100 may consume resources of the PIT to process the fake interest messages. In detail, since a fake interest message refers to content not present, content corresponding to the fake interest message may not be found in the content storage. Therefore, the node 100 may record a content name corresponding to the fake interest message, and a network interface through which the fake interest message is received, in the PIT. In addition, the node 100 may transmit the fake interest message to another network node by referencing the content routing table.

In addition, since the fake interest message refers to the content not present, the node 100 may not receive data including the content corresponding to the fake interest message although time passes by. The PIT stores the content name corresponding to the fake interest message, and the network interface through which the fake interest message is received, until the data including the content is received. Therefore, the content name and the network interface that correspond to the fake interest message are stored in the PIT until being identified and deleted. As a result, a capacity of the PIT to store a content name corresponding to a normal interest message, and a network interface through which the normal interest message is received, may be reduced.

In this state, the node 100 may receive only the content corresponding to the content name stored in the PIT. Even with respect to data including content that is received from another node, the node 100 may transmit the data to a following node only when a content name corresponding to the content and included in the normal interest message is stored in the PIT. Therefore, the node 100 defers processing of the normal interest message until other interest messages are processed and the capacity of the PIT is secured.

That is, as the fake interest message increase, the resources of the PIT that may be used by the node 100 to process the normal interest message may decrease. Accordingly, a waiting time for the normal interest message to wait to use the resources may be increased. That is, processing of the normal interest message may be delayed.

Therefore, the example of the attack detection apparatus that is described herein may detect an attack with respect to the network system by detecting an abnormal increase of traffic. The traffic may denote a quantity of interest messages received by the node 100.

In detail, the attack detection apparatus may vary a size of a window applied to the traffic to detect an abnormal state of traffic, thereby accurately detecting continuity of the abnormal state even when the abnormal state lasts longer than the window size. Also, the attack detection apparatus may determine the attack, using a ratio between one or more interest messages received by the node 100 and data transmitted by the node 100 to another node according to the interest messages. Since a fake interest message used by an attacker requests content not present, the node 100 may not receive nor transmit data corresponding to the fake interest message.

That is, when the ratio between the interest messages received by the node 100 and the data transmitted by the node 100 to the other node according to the interest messages is relatively high, the traffic may be normal messages requesting content and responding. However, when the ratio is relatively low, the traffic may be fake interest messages used by the attacker. Therefore, the attack detection apparatus may detect the attack with respect to the network system without having to monitor the entire network system, by determining the attack, using the ratio between the received interest messages and the transmitted data corresponding to the interest messages.

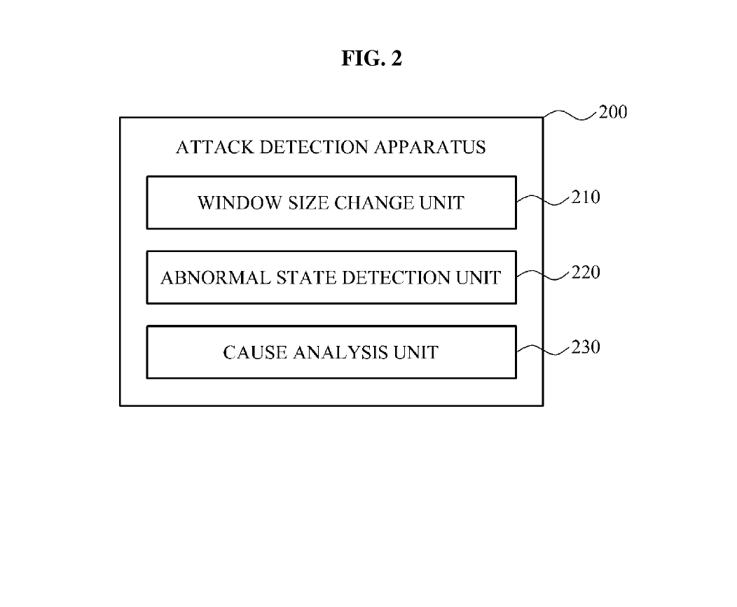

FIG. 2 is a diagram illustrating an example of an attack detection apparatus 200. Referring to FIG. 2, the attack detection apparatus 200 includes a window size change unit 210, an abnormal state detection unit 220, and a cause analysis unit 230.

The window size change unit 210 changes a size of a window applied to traffic of the node 100. The window size change unit 210 may change the size of the window, according to a first variation denoting a scale and a continuity of a variation of the traffic. The first variation may be determined using a second variation denoting a direction of the variation of the traffic.

In detail, the window size change unit 210 may calculate a simple variation I_{d(n)} of the traffic, using Equation 1:

I_{d(n)}=I₍ₙ₎−I₍ₙ₋₁₎ [Equation 1]

In Equation 1, I₍ₙ₎ may refer to the traffic of the node 100 at an n time.

Next, the window size change unit 210 may calculate the second variation A₍ₙ₎ denoting the direction of the simple variation of the traffic, using Equation 2 below. The second variation may be a smoothed series or a smoothed variation.

A₍ₙ₎=αI_{d(n)}×(1−α)A₍ₙ₋₁₎ [Equation 2]

In Equation 2, α may refer to one of predetermined constants.

Next, the window size change unit 210 may calculate the first variation Aₐᵥ₍ₙ₎, which is an average of the second variation, using Equation 3:

Aav₍ₙ₎=AVERAGE(A₍ₙ₋ₖ₊₁₎:A₍ₙ₎) [Equation 3]

In Equation 3, k may denote the size of the window applied to the traffic.

The window size change unit 210 may change the window size such that the traffic from a time when the first variation is greater than 0 to a time when the first variation is less than 0, is included in the window. In further detail, the window size change unit 210 may set a counter that is a variable to detect a continuity of an abnormal state of the traffic. In addition, the window size change unit 210 may determine a value of the counter, using Equation 4:

if (Aav₍ₙ₋₁₎=0)counter=0

else counter=counter+1 [Equation 4]

That is, the window size change unit 210 may initialize the counter value to 0 when the first variation is 0, and may increase the counter value when the first variation is not 0.

When the counter value is greater than 0, the window size change unit 210 may calculate Aavₜₑₘₚ₍ₙ₎, which denotes an average of the second variation from a time when the counter value is 1 to a time n. In this example, the window size change unit 210 may set the Aavₜₑₘₚ₍ₙ₎ to be equal to A₍ₙ₎ when the counter value is 1 at the time n. When the counter value is greater than 0 from a time n+1, the window size change unit 210 may calculate the average Aavₜₑₘₚ₍ₙ₎ of the second variation, using Equation 5:

$${Aav}_{temp ( n )} = max \{ 0 , \frac{( ( c - 1 ) \times {Aav}_{temp ( n - 1 )} ) + {A}_{( n )}}{c} \} \qquad [ Equation 5 ]$$

In Equation 5, c may denote the counter value.

In addition, the window size change unit 210 may change the window size to a predetermined default size w of the window when the counter value is less than or equal to the default size w. When the counter value is greater than the default size w, the window size change unit 210 may change the window size to the counter value. In this example, the window size change unit 210 may calculate the first variation, using Equation 6:

$${Aav}_{( n )} = \{ \begin{matrix}max \{ 0 , \frac{{\sum }_{i = n - w + 1}^{n} {A}_{( i )}}{w} \} & , if counter \leq w \\ {Aav}_{temp ( n )} & , otherwise\end{matrix} \qquad [ Equation 6 ]$$

That is, when the counter value is less than or equal to the predetermined default size of the window, the window size change unit 210 may change the window size to the default size w, and calculate the first variation to be the average of the second variation included in the window of the default size. Also, when the counter value is greater than the predetermined default size of the window, the window size change unit 210 may change the window size to the counter value, and calculate the first variation to be the average of the second variation included in the window of the changed size.

The abnormal state detection unit 220 detects the abnormal state of the traffic to which the window changed by the window size change unit 210 is applied. In detail, the abnormal state detection unit 220 may determine the abnormal state when the first variation of the traffic to which the window is applied exceeds a predetermined threshold.

The cause analysis unit 230 analyzes a cause of the abnormal state detected by the abnormal state detection unit 220, using one or more interest message and data corresponding to the interest messages. In detail, when the node 100 transmits the interest message received from the user node 120 to the content node 130, the content node 130 may transmit the data including content to the node 100 in response to the interest message. When an average response rate of the content node 130 with respect to the node 100 is β, the node 100 may receive, at time n+β, the data corresponding to the interest message received at the time n. Therefore, the cause analysis unit 230 may calculate a response ratio between a quantity of the data received from the content node 130 and transmitted to the user node 120, and a quantity of data (the interest message) received from the user node 120.

When the network system is not attacked, the response ratio may satisfy Equation 7:

$$γ \leq \frac{{D}_{( n + β )}}{{I}_{( n )}} \leq 1 \qquad [ Equation 7 ]$$

In Equation 7, D_{(n+β)} denotes an outgoing data traffic volume output by the node 100 at the time n+β, I₍ₙ₎ denotes an incoming data traffic volume received by the node 100 at the time n, and γ denotes an average of the response ratio. When the network system is not attacked, the outgoing data traffic volume of the node 100 at the time n+β (e.g., the quantity of the data that the node 100 received from the content node 130 and transmitted to the user node 120) may correspond to the incoming data traffic volume of the node 100 at the time n (e.g., the quantity of the data that the node 100 received from the user node 120).

However, when the network system is attacked, the response ratio may be decreased to less than the average γ of the response ratio since the attacker transmits a great quantity of interest messages requesting data not present in the network system to disable the network system. Accordingly, the cause analysis unit 230 may determine that the network system is attacked when the response ratio decreases to less than the average γ of the response ratio. However, depending on communication states, the response ratio may be a bit less than the average γ of the response ratio even when the network system is not attacked.

Therefore, the cause analysis unit 230 may set a threshold ε of a normal response ratio, and when the response ratio satisfies Equation 8 below, the cause analysis unit 230 may determine that the network system is attacked.

$$\frac{{D}_{( n + β )}}{{I}_{( n )}} < ɛ < γ \leq 1 \qquad [ Equation 8 ]$$

Additionally, the cause analysis unit 230 may analyze the cause of the abnormal state, using an occurrence ratio of fake interest messages. In detail, the cause analysis unit 230 may calculate the occurrence ratio of the fake interest messages of which corresponding data may not be transmitted by the time n+β, among interest messages received by the node 100 at the time n. When the calculated occurrence ratio exceeds a predetermined threshold, the cause analysis unit 230 may determine that the network system is attacked.

In addition, the cause analysis unit 230 may measure a quantity of fake interest messages of which corresponding data may not be transmitted by the time period n+β, among interest messages received by the node 100 at the time n. When the measured quantity exceeds a predetermined threshold, the cause analysis unit 230 may determine that the network system is attacked.

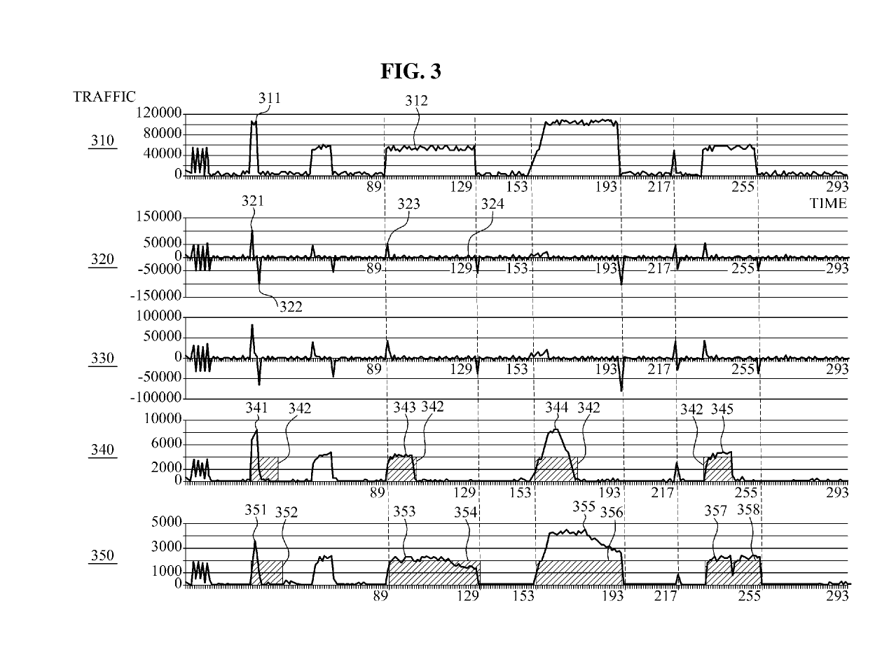

FIG. 3 is a graph illustrating an example of a variation used by an attack detection apparatus. An incoming data traffic volume 310 (“traffic”) received by the node 100, according to time, includes a fast increasing section 311 in which a volume is greatly increased for a short period, and a slow increasing section 312 in which the volume is increased for a long period, as shown in FIG. 3.

The window size change unit 210 may calculate a simple variation 320 of the traffic, using Equation 1. The simple variation 320 indicates an increase or decrease of the traffic, according to time. That is, as shown in FIG. 3, when the traffic increases at times, the simple variation 320 has respective positive values 321 and 323 corresponding to the increases of the traffic. When the traffic decreases at times, the simple variation 320 has respective negative values 322 and 324 corresponding to the decreases of the traffic.

Next, the window size change unit 210 may calculate a second variation 330 denoting a direction of the simple variation 320 of the traffic, using Equation 2. The second variation 330 may be a smoothed series or a smoothed variation.

Next, the window size change unit 210 may calculate a first variation 350 denoting an average of the second variation 330. A conventional attack detection apparatus may calculate an average 340 of the second variation included in a window 342 having a fixed size as shown in FIG. 3. Therefore, when a time period during which the traffic is increased is less than the size of the window 342, as in a section 341, a section in which the traffic is increased may be detected accurately. However, when a time period during which the traffic is increased is greater than the size of the window 342, as in each of sections 343, 344, and 345, only a section corresponding to the size of the window 342 out of the time in which the traffic is increased may be detected.

As shown in FIG. 3, conversely, in a section 351 in which a time period during which the traffic is increased is less than a default size of a window 352, the window size change unit 210 may calculate the first variation 350, using the window 352. Accordingly, an amount of calculation may be reduced. In addition, with respect to each of sections 353, 355, and 357 in which a time period during which the traffic is increased is greater than the default size of the window 352, the window size change unit 210 may calculate the first variation 350, using windows 354, 356, and 358, respectively, which have respective sizes changed by the window size change unit 210 to correspond to lengths of the sections 353, 355, and 357. That is, the attack detection apparatus 200 may accurately detect a continuity of an abnormal state of the traffic even when the abnormal state lasts longer than a window size, by changing the window size applied to the traffic to detect the abnormal state.

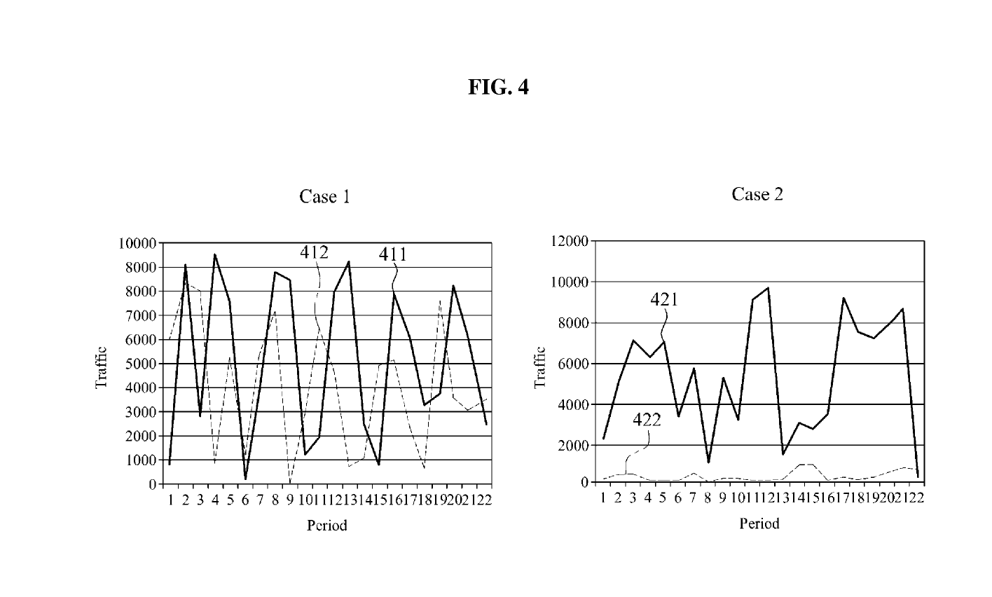

FIG. 4 is a graph illustrating an example of a response rate used by an attack detection apparatus. When the node 100 transmits an interest message received from the user node 120 to the content node 130, the content node 130 may transmit data including content to the node 100 in response to the interest message. Next, the node 100 may transmit the data received from the content node 130 to the user node 120.

Therefore, when a network system is not attacked, as shown in case 1, an outgoing data traffic volume 412 denoting a volume of data output by the node 100 is varied according to an incoming data traffic volume 411 denoting a volume of interest messages received by the node 100. The outgoing data traffic volume 412 is changed after a predetermined time elapsed from a time at which the incoming data traffic volume 411 is changed.

However, when the network system is attacked, an attacker may transmit a great quantity of fake interest messages requesting for data not present in the network system, so as to disable the network system. In this example, the node 100 may not be able to transmit the data with respect to the fake interest messages.

Therefore, when the network system is attacked, as shown in case 2, an outgoing data traffic volume 422 is considerably less than an incoming data traffic volume 421. The outgoing data traffic volume 422 corresponds to a volume of normal interest messages requesting data present in the network system. However, most of increased traffic volume of the incoming data traffic volume 421 may be the fake interest messages. Accordingly, the outgoing data traffic volume 422 does not correspond to the incoming data traffic volume 421.

That is, when the network system is attacked, the outgoing data traffic volume 422 is decreased in comparison to the incoming data traffic volume 421, according to the increase in the fake interest messages. Accordingly, a response ratio between the outgoing data traffic volume 422 and the incoming data traffic volume 421 is also decreased. Therefore, using the response ratio, the attack detection apparatus 200 may detect the attack with respect to the network system without monitoring the entire network system.

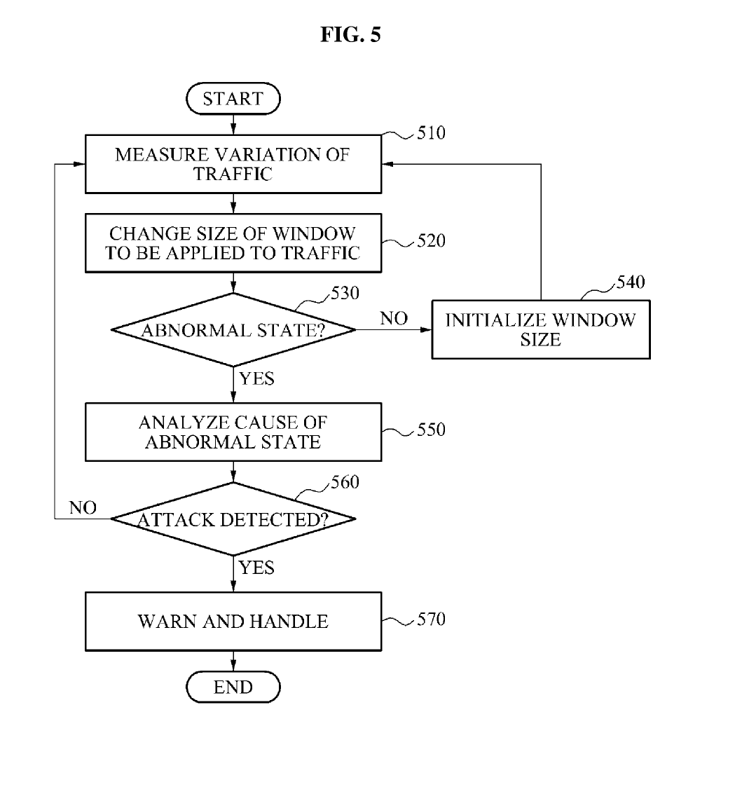

FIG. 5 is a flowchart illustrating an example of an attack detection method. In operation 510, the window size change unit 210 measures a variation of traffic. In detail, the window size change unit 210 may calculate a simple variation I_{d(n)} of the traffic, using Equation 1. Next, the window size change unit 210 may calculate a second variation A₍ₙ₎ denoting a direction of the simple variation of the traffic, using Equation 2. Next, the window size change unit 210 may calculate the first variation, which is an average of the second variation.

In operation 520, the window size change unit 210 changes a size of a window to be applied to the traffic, using the first variation calculated in operation 510. For example, the window size change unit 210 may change the window size such that the traffic from a time when the first variation is greater than 0 to a time when the first variation is less than 0, is included in the window.

In detail, the window size change unit 210 may initialize a counter value to 0 when the first variation is 0, and may increase the counter value when the first variation is not 0. The window size change unit 210 may change the window size to a predetermined default size w when the counter value is less than the default size w. When the counter value is greater than the predetermined default size w, the window size change unit 210 may change the window size to the counter value.

When the counter value is less than the default size w, the window size change unit 210 may change the window size to the default size w, and calculate the average of the second variation included in the changed window as the first variation. In addition, when the counter value is greater than the default size w, the window size change unit 210 may change the window size to the counter value, and calculate the average of the second variation included in the changed window as the first variation.

In operation 530, the abnormal state detection unit 220 detects whether an abnormal state of the traffic occurs, using the traffic to which the window changed by the window size change unit 210 in operation 520 is applied. In detail, the abnormal state detection unit 220 may detect that the abnormal state occurs when the first variation exceeds a predetermined threshold. When the abnormal state is not detected to occur, the window size change unit 210 performs operation 540. When the abnormal state is detected to occur, the cause analysis unit 230 performs operation 550.

In operation 540, the window size change unit 210 initializes the window size. In detail, the window size change unit 210 may change the window size to the default size, and initialize the counter value to 0.

In operation 550, the cause analysis unit 230 analyzes a cause of the abnormal state detected by the abnormal state detection unit 220, using one or more interest messages and data corresponding to the interest messages. In detail, the cause analysis unit 230 may determine that the network system is attacked when a response ratio between a quantity of the interest messages received by the node 100 and a quantity of the data transmitted by the node 100 in response to the interest messages, is less than an average response ratio.

In operation 560, the cause analysis unit 230 confirms whether the attack with respect to the network system is detected in operation 550. When the attack with respect to the network system is not confirmed to be detected, the window size change unit 210 performs operation 510. When the attack with respect to the network system is confirmed to be detected, the window size change unit 210 performs operation 570.

In operation 570, the cause analysis unit 230 warns a user that the network system is attacked, and handles the attack. For example, the cause analysis unit 230 may identify a node transmitting a great quantity of the fake interest messages, and interrupt the node from accessing other nodes.

The various units, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

As a non-exhaustive illustration only, a user node described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blue-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An attack detection apparatus comprising:
a window size change unit configured to change a size of a window to be applied to traffic; and
an abnormal state detection unit configured to detect an abnormal state of the traffic to which the changed window is applied.

2. The attack detection apparatus of claim 1, wherein the window size change unit is configured to change the window size based on a first variation denoting a scale and a continuity of a variation of the traffic.

3. The attack detection apparatus of claim 2, wherein the window size change unit is configured to determine the first variation based on a second variation denoting a direction of the variation of the traffic.

4. The attack detection apparatus of claim 2, wherein the window size change unit is configured to change the window size such that the traffic from a time when the first variation is not 0 to a time when the first variation is 0, is included in the window.

5. The attack detection apparatus of claim 2, wherein the window size change unit is configured to change the window size to a default size in response to a time period from a time when the first variation is not 0 to a time when the first variation is 0, being less than the default size.

6. The attack detection apparatus of claim 2, wherein the abnormal state detection unit is configured to determine that the abnormal state occurs in response to the first variation exceeding a predetermined threshold.

7. The attack detection apparatus of claim 1, further comprising:
a cause analysis unit configured to analyze a cause of the abnormal state based on an interest message and data corresponding to the interest message.

8. The attack detection apparatus of claim 7, wherein the cause analysis unit is configured to analyze the cause of the abnormal state based on a ratio between the interest message received by a node and the data transmitted by the node.

9. The attack detection apparatus of claim 7, wherein:
the cause analysis unit is configured to analyze the cause of the abnormal state based on an occurrence ratio of a fake interest message; and
the fake interest message requests data not present in a network system.

10. An attack detection apparatus comprising:
an abnormal state detection unit configured to detect an abnormal state of traffic of a node; and
a cause analysis unit configured to analyze a cause of the abnormal state based on an interest message and data corresponding to the interest message.

11. The attack detection apparatus of claim 10, wherein the cause analysis unit is configured to analyze the cause of the abnormal state based on a ratio between the interest message received by the node and the data transmitted by the node.

12. The attack detection apparatus of claim 10, wherein:
the cause analysis unit is configured to analyze the cause of the abnormal state based on an occurrence ratio of a fake interest message; and
the fake interest message requests data not present in a network system.

13. The attack detection apparatus of claim 10, further comprising:
a window size change unit configured to change a size of a window to be applied to the traffic,
wherein the window size change unit is configured to change the window size based on a first variation denoting a scale and a continuity of a variation of the traffic, and
wherein the abnormal state detection unit is configured to detect the abnormal state of the traffic to which the changed window is applied.

14. The attack detection apparatus of claim 13, wherein the window size change unit is configured to change the window size such that the traffic from a time when the first variation is greater than 0 to a time when the first variation is less than 0, in included in the window.

15. The attack detection apparatus of claim 13, wherein the window size change unit is configured to change the window size to a default size in response to a time period from a time when the first variation is not 0 to a time when the first variation is 0, being less than the default size.

16. An attack detection method comprising:
changing a size of a window to be applied to traffic of a node; and
detecting an abnormal state of the traffic to which the changed window is applied.

17. The attack detection method of claim 16, further comprising:
analyzing a cause of the abnormal state based on an interest message and data corresponding to the interest message.

18. The attack detection method of claim 16, wherein the detecting comprises detecting whether the node is attacked based on the traffic to which the changed window is applied and a ratio between one or more interest messages received by the node and data transmitted by the node that corresponds to the interest messages.

19. The attack detection method of claim 18, wherein the changing comprises:
changing the size of the window to a default size in response to a time period from a time when a first variation of the traffic is not 0 to a time when the first variation is 0, being less than the default size; and
changing the size of the window to be greater than a default size in response to the time period being greater than the default size.

20. The attack detection method of claim 18, wherein the detecting comprises detecting that the node is attacked in response to a first variation of the traffic to which the changed window is applied, exceeding a predetermined threshold, and the ratio being less than an average of the ratio.
